(19) United States
(12) Patent Application Publication
(10) Pub. No.: US 2013/0321067 A1
(43) Pub. Date: Dec. 5, 2013

(54) SEMICONDUCTOR DEVICE

(71) Applicant: Dong-Kyun KIM, Gyeonggi-do (KR)

(72) Inventor: Dong-Kyun KIM, Gyeonggi-do (KR)

(21) Appl. No.: 13/486,770

(22) Filed: Jun. 1, 2012

(51) Int. Cl. G05F 1/10

(52) U.S. Cl. 327/536; 327/538

(57) ABSTRACT

A semiconductor device includes: a first reference voltage generation unit configured to generate a first reference voltage having a negative property in correspondence to an increase of the temperature; a second reference voltage generation unit configured to generate a second reference voltage having a positive property in correspondence to an increase of the temperature; a voltage level detection unit configured to select any one of the first and second reference voltages according to a voltage selection signal, and detect a level of an internal voltage based on a level of the selected voltage; and an internal voltage generation unit configured to generate the internal voltage in response to an output signal of the voltage level detection unit.

### BACKGROUND

1. Field

Exemplary embodiments of the present invention relate to a semiconductor design technology, and more particularly, to an internal voltage generation circuit of a semiconductor device.

2. Description of the Related Art

With high speed, high density, and low power consumption of a semiconductor integration circuit, a semiconductor device represented by DRAM generates and uses internal voltages with a variety of voltage levels, in addition to power supply voltages (VDD, VSS and so on) supplied from outside. In order to generate an internal voltage, a reference voltage is generated, and the generated reference voltage is used to generate the internal voltage through charge pumping or voltage down converting.

A representative internal voltage using charge pumping may include a boosted voltage VPP and a back bias voltage VBB. Furthermore, a representative internal voltage using voltage down converting may include a core voltage VCORE.

In general, the boosted voltage VPP is generated to apply a higher voltage than an external power supply voltage VDD to a gate of a cell transistor (or word line) to access a cell without a loss of cell data.

The back bias voltage VBB is used to increase stability by reducing a change in threshold voltage Vt caused by a body effect for the cell transistor, and reduce a channel leakage current. That is, the back bias voltage VBB is generated to apply a lower voltage than an external ground voltage VSS to a bulk of the cell transistor, in order to prevent a loss of data stored in the cell transistor.

The core voltage VCORE is generated by using an operational amplifier OP-AMP or the like. At this time, in order to reduce power consumption and guarantee a stable operation of a core, an external power supply voltage VDD is down-converted in such a manner that the core voltage VCORE is lower than the external power supply voltage VDD and maintains a constant potential with respect to variations of the external power supply voltage VDD within an operation region.

An internal voltage generator for generating the above-described internal voltages VPP, VBB, and VCORE is designed to operate with a constant deviation within an operational voltage region and an operational range temperature of a semiconductor memory device.

FIG. 1 is a graph showing variations in the voltage level of a threshold voltage Vt depending on the temperature, in a CMOS transistor used in a conventional semiconductor memory device.

Referring to FIG. 1, it can be seen that, as the temperature increases, the threshold voltage Vt of the CMOS transistor of the conventional semiconductor memory device linearly decreases.

Vt(t)−Vt(0)−α(T−T0) Eq. 1

In Equation 1, ‘Vt(0)’ represents a threshold voltage Vt at room temperature ‘T0’, and ‘α’ represents a proportional constant. That is, as the temperature increases, the threshold voltage Vt linearly decreases, and as the temperature decreases, the threshold voltage Vt linearly increases.

Vt=Vt(VBB=0V)+α\sqrt{|VBB|} Eq. 2

As in Equation 2, the threshold voltage Vt may be represented by a function based on the voltage level of a back bias voltage VBB applied to a back bias terminal of a CMOS transistor. That is, as the absolute value of the back bias voltage VBB increases, the voltage level of the threshold voltage Vt increases, and as the absolute value of the back bias voltage VBB decreases, the voltage level of the threshold voltage Vt decreases.

FIG. 2 is a graph showing that the voltage level of a back bias reference voltage VREFB used to generate the back bias voltage VBB applied to the back bias terminal of the CMOS transistor of FIG. 1 varies according to the temperature.

Referring to FIG. 2, it can be seen that the voltage level of the back bias reference voltage VREFB varies while having a negative property with respect to an increase of the temperature. Specifically, as the temperature increases from −5° C. to 93° C., the voltage level of the back bias reference voltage VREFB decreases by −20 mV. Therefore, the voltage level of the back bias voltage VBB also varies while having a negative property with respect to an increase of the temperature.

Meanwhile, when the temperature increases, the drain-source contact resistance of a cell transistor in the semiconductor memory device decreases, and the threshold voltage Vt of the cell transistor decreases as in Equation 1. Simultaneously, the level of the back bias voltage VBB also decreases.

Accordingly, the voltage level of the threshold voltage Vt of the CMOS transistor decreases to increase a leakage current. Furthermore, since an operation current increases, the current consumption may be increased to more than a limit.

### SUMMARY

An embodiment of the present invention is directed to a semiconductor device which stably operates even when the temperature increases.

In accordance with an embodiment of the present invention, a semiconductor device includes: a first reference voltage generation unit configured to generate a first reference voltage having a negative property in correspondence to an increase of the temperature; a second reference voltage generation unit configured to generate a second reference voltage having a positive property in correspondence to an increase of the temperature; a voltage level detection unit configured to select any one of the first and second reference voltages according to a voltage selection signal, and detect a level of an internal voltage based on a level of the selected voltage; and an internal voltage generation unit configured to generate the internal voltage in response to an output signal of the voltage level detection unit.

### BRIEF DESCRIPTION OF THE DRAWINGS

FIG. 1 is a graph showing variations in the voltage level of a threshold voltage Vt depending on the temperature, in a CMOS transistor used in a conventional semiconductor memory device.

FIG. 2 is a graph showing that the voltage level of a back bias reference voltage used to generate a back bias voltage applied to a back bias terminal of the CMOS transistor of FIG. 1 varies according to the temperature.

FIG. 3 is a block diagram illustrating an internal voltage generation circuit of a semiconductor memory device in accordance with an embodiment of the present invention.

FIG. 4 is a graph showing that the voltage level of a back bias reference voltage used in the internal voltage generation circuit of the semiconductor memory device illustrated in FIG. 3 varies according to the temperature.

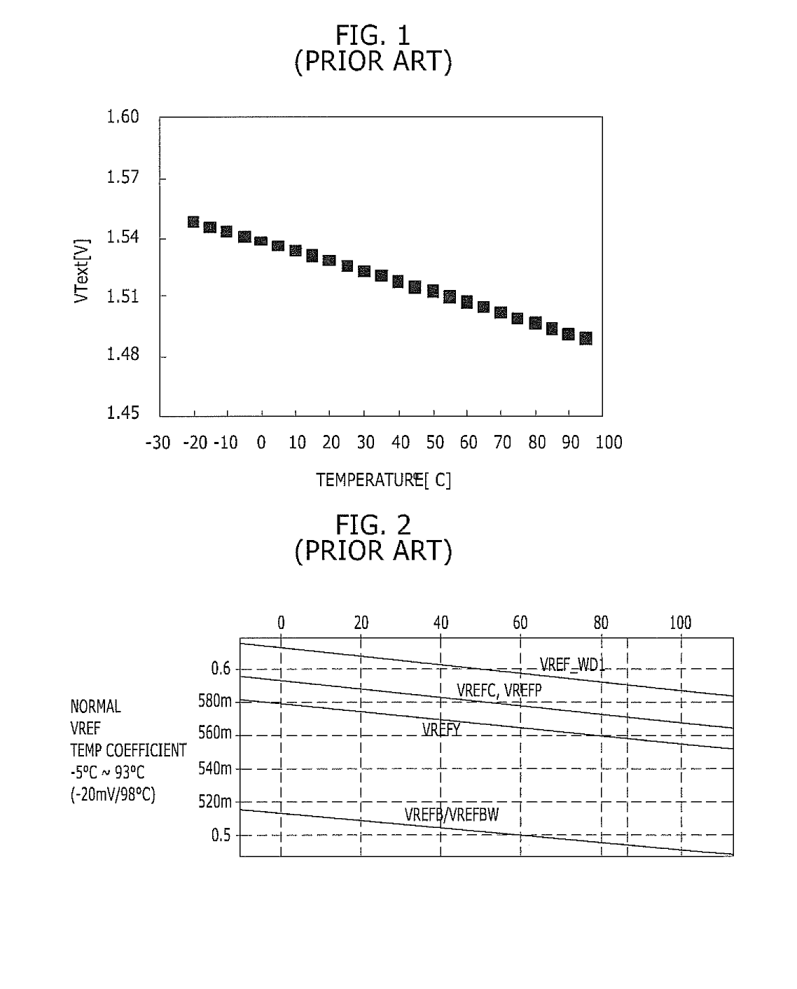

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

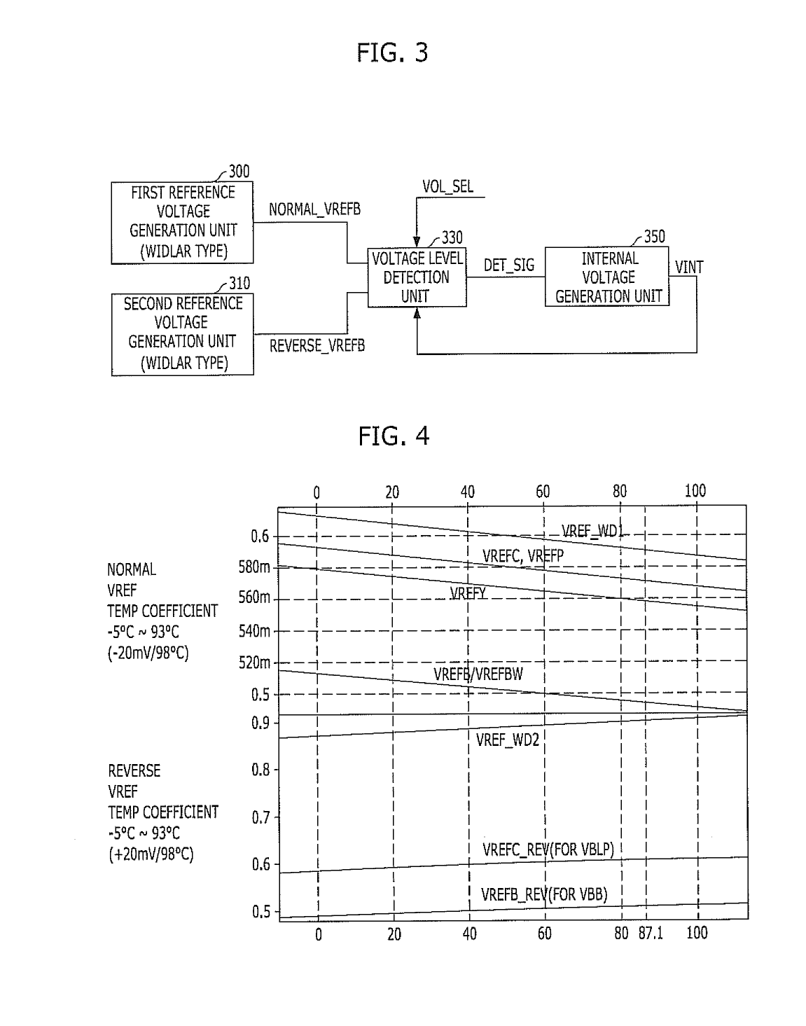

FIG. 3 is a block diagram illustrating an internal voltage generation circuit of a semiconductor memory device in accordance with an embodiment of the present invention.

Referring to FIG. 3, the internal voltage generation circuit includes a first reference voltage generation unit 300, a second reference voltage generation unit 310, a voltage level detection unit 330, and an internal voltage generation unit 350. The first reference voltage generation unit 300 is configured to generate a first reference voltage NORMAL_VREFB having a negative property in correspondence to an increase of the temperature. The second reference voltage generation unit 310 is configured to generate a second reference voltage REVERSE_VREFB having a positive property in correspondence to an increase of the temperature. The voltage level detection unit 330 is configured to select any one of the first and second reference voltages NORMAL_VREFB and REVERSE_VREFB according to a voltage selection signal VOL_SEL and detect the level of an internal voltage VINT based on the level of the selected voltage. The internal voltage generation unit 350 is configured to generate the internal voltage VINT in response to an output signal DET_SIG of the voltage level detection unit 330.

The voltage level detection unit 330 selects the first reference voltage NORMAL_VREFB in response to the voltage selection signal VOL_SEL activated in a normal operation mode such that the detection reference level of the internal voltage VINT has a negative property with respect to an increase of the temperature. On the contrary, the voltage level detection unit 330 selects the second reference voltage REVERSE_VREFB in response to the voltage selection signal VOL_SEL deactivated in a reverse operation mode such that the detection reference level of the internal voltage INT has a positive property with respect to an increase of the temperature.

The internal voltage generation unit 350 may have the following two configurations.

First, the operation of the internal voltage generation unit 350 may be controlled to be turned on/off in response to the output signal DET_SIG of the voltage level detection unit 330, and the internal voltage VINT may be generated from an external power supply voltage VDD through voltage down converting.

As such, the internal voltage generated through the voltage down converting by the internal voltage generation unit 350 may be used as a line precharge voltage. That is, the internal voltage VINT may be used to precharge two or more set lines which are not illustrated in the drawing.

Second, the operation of the internal voltage generation unit 350 may be controlled to be turned on/off in response to the detection signal DET_SIG of the voltage level detection unit 330, and the internal voltage VINT may be generated from an external power supply voltage VDD through charge pumping.

As such, the internal voltage VINT generated through the charging pumping by the internal voltage generation unit 350 may be used as a back bias voltage. That is, the internal voltage VINT may be applied to a back bias terminal of a set transistor which is not illustrated in the drawing, and used to control the threshold voltage level of the set transistor.

FIG. 4 is a graph showing that the voltage level of a back bias reference voltage used in the internal voltage generation circuit of the semiconductor memory device illustrated in FIG. 3 varies according to the temperature.

For reference, the internal voltage VINT in FIG. 4 means a back bias voltage VBB.

Referring to FIG. 4, the first reference voltage NORMAL_VREFB generated by the first reference voltage generation unit 300 among the components of the internal voltage generation circuit of the semiconductor memory device in accordance with the embodiment of the present invention has a negative property in correspondence to an increase of the temperature. However, the second reference voltage REVERSE_VREFB generated by the second reference voltage generation unit 310 has a positive property in correspondence to an increase of the temperature.

Therefore, when the voltage level detection unit 330 detects the level of the back bias voltage VBB by using the first reference voltage NORMAL_VREFB, it becomes the same state as in the conventional semiconductor memory device. Thus, the level of the back bias voltage VBB decreases with respect to an increase of the temperature.

However, when the voltage level detection unit 330 detects the level of the back bias voltage VBB by using the second reference voltage REVERSE_VREFB, the level of the back bias voltage VBB increases with respect to an increase of the temperature.

When the back bias voltage VBB is applied to the back bias terminal of the CMOS transistor in a state in which the level of the back bias voltage VBB is controlled to increase with respect to an increase of the temperature, it is possible to substantially prevent the level decrease of the threshold voltage Vt caused by an increase of the temperature. That is, an operation of decreasing the threshold voltage Vt of the CMOS transistor due to an increase of the temperature and an operation of increasing the threshold voltage Vt of the CMOS transistor while the level of the back bias voltage VBB applied to the back bias terminal of the CMOS transistor increases according to an increase of the temperature occur at the same time. Accordingly, the threshold voltage Vt of the CMOS transistor may not vary even though the temperature increases.

Therefore, the magnitude of a leakage current occurring between the source and the drain of the CMOS transistor may be constantly maintained regardless of an increase of the temperature. Thus, since the operation current is constantly maintained regardless of an increase of the temperature, the current consumption may not be increased to more than a limit.

In accordance with the embodiment of the present invention, the level of the internal voltage may be controlled to increase with respect to an increase of the temperature. Therefore, when the internal voltage is a back bias voltage applied to the back bias terminal of the CMOS transistor, the threshold voltage Vt of the CMOS transistor maintains a constant voltage level regardless of an increase of the temperature. Accordingly, the magnitude of a leakage current occurring between the source and the drain of the CMOS transistor may be constantly maintained regardless of an increase of the temperature. Furthermore, since the operation current is constantly maintained regardless of an increase of the temperature, the current consumption may not be increased to more than a limit.

While the present invention has been described with respect to the specific embodiments, it will be apparent to those skilled in the art that various changes and modifications may be made without departing from the spirit and scope of the invention as defined in the following claims.

1. A semiconductor device comprising:
a first reference voltage generation unit configured to generate a first reference voltage having a negative temperature property;
a second reference voltage generation unit configured to generate a second reference voltage having a positive temperature property;
a voltage level detection unit configured to select any one of the first and second reference voltages according to a voltage selection signal, and detect a level of an internal voltage based on a level of the selected reference voltage; and
an internal voltage generation unit configured to generate the internal voltage in response to an detection signal output from the voltage level detection unit.

2. The semiconductor device of claim 1, wherein the voltage level detection unit selects the first reference voltage in response to the voltage selection signal activated in a normal operation mode such that a detection reference level of the internal voltage has the negative temperature property.

3. The semiconductor device of claim 2, wherein the voltage level detection unit selects the second reference voltage in response to the voltage selection signal deactivated in a reverse operation mode such that the detection reference level of the internal voltage has the positive temperature property.

4. The semiconductor device of claim 3, wherein an operation of the internal voltage generation unit is controlled to be turned on/off in response to the detection signal, and the internal voltage generation unit generates the internal voltage from an external power supply voltage through voltage down converting.

5. The semiconductor device of claim 4, wherein the internal voltage is used as a line precharge voltage to precharge two or more set lines.

6. The semiconductor device of claim 3, wherein an operation of the internal voltage generation unit is controlled to be turned on/off in response to the detection signal, and the internal voltage generation unit generates the internal voltage from an external power supply voltage through charge pumping.

7. The semiconductor device of claim 6, wherein the internal voltage is used as a back bias voltage which is applied to a back bias terminal of a set transistor to control a threshold voltage level of the set transistor.
